(19) United States
(12) Patent Application Publication
(10) Pub. No.: US 2016/0259728 A1
(43) Pub. Date: Sep. 8, 2016

(54) CACHE SYSTEM WITH A PRIMARY CACHE AND AN OVERFLOW FIFO CACHE

(71) Applicant: VIA ALLIANCE SEMICONDUCTOR CO., LTD., Shanghai (CN)

(72) Inventors: COLIN EDDY, Austin, TX (US); RODNEY E. HOOKER, Austin, TX (US)

(21) Appl. No.: 14/889,114

(22) PCT Filed: Dec. 12, 2014
(86) PCT No.: PCT/IB2014/003250

§ 371 Date: Nov. 4, 2015

Related U.S. Application Data
(60) Provisional application No. 62/061,242, filed on Oct. 8, 2014.

(51) Int. Cl. G06F 12/08; G06F 12/12; G06F 12/10

(52) U.S. Cl. CPC G06F 12/0833; G06F 12/0811; G06F 12/1027; G06F 12/128; G06F 2212/283; G06F 2212/69; G06F 2212/68

(57) ABSTRACT

A cache memory system including a primary cache and an overflow cache that are searched together using a search address. The overflow cache operates as an eviction array for the primary cache. The primary cache is addressed using bits of the search address, and the overflow cache is configured as a FIFO buffer. The cache memory system may be used to implement a translation lookaside buffer for a microprocessor.

### CROSS-REFERENCE TO RELATED APPLICATIONS

This application claims the benefit of U.S. Provisional Application Ser. No. 62/061,242, filed on Oct. 8, 2014 which is hereby incorporated by reference in its entirety for all intents and purposes.

### BACKGROUND OF THE INVENTION

1. Field of the Invention

The present invention relates in general to microprocessor caching systems, and more particularly to a caching system with a primary cache and an overflow FIFO cache.

2. Description of the Related Art

Modern microprocessors include a memory cache system for reducing memory access latency and improving overall performance. System memory is external to the microprocessor and accessed via a system bus or the like so that system memory access is relatively slow. Generally, a cache is a smaller, faster local memory component that transparently stores data retrieved from the system memory in accordance with prior requests so that future requests for the same data may be retrieved more quickly. The cache system itself is typically configured in a hierarchical manner with multiple cache levels, such as including a smaller and faster first-level (L1) cache memory and a somewhat larger and slower second-level (L2) cache memory. Although additional levels may be provided, they are not discussed further since additional levels operate relative to each other in a similar manner, and since the present disclosure primarily concerns the configuration of the L1 cache.

When the requested data is located in the L1 cache invoking a cache hit, the data is retrieved with minimal latency. Otherwise, a cache miss occurs in the L1 cache and the L2 cache is searched for the same data. The L2 cache is a separate cache array in that it is searched separately from the L1 cache. Also, the L1 cache is typically smaller and faster than the L2 cache with fewer sets and/or ways. When the requested data is located in the L2 cache invoking a cache hit in the L2 cache, the data is retrieved with increased latency as compared to the L1 cache. Otherwise, if a cache miss occurs in the L2 cache, then the data is retrieved from higher cache levels and/or system memory with significantly greater latency as compared to the cache memory.

The retrieved data from either the L2 cache or the system memory is stored in the L1 cache. The L2 cache serves as an “eviction” array in that an entry evicted from the L1 cache is stored in the L2 cache. Since the L1 cache is a limited resource, the newly retrieved data may displace or evict an otherwise valid entry in the L1 cache, referred to as a “victim.” The victims of the L1 cache are thus stored in the L2 cache, and any victims of the L2 cache are stored in higher levels, if any, or otherwise discarded. Various replacement policies may be implemented, such as least-recently used (LRU) or the like as understood by those of ordinary skill in the art.

Many modern microprocessors also include virtual memory capability, and in particular, a memory paging mechanism. As is well known in the art, the operating system creates page tables that it stores in system memory that are used to translate virtual addresses into physical addresses. The page tables may be arranged in a hierarchical fashion, such as according to the well-known scheme employed by x86 architecture processors as described in Chapter 3 of the IA-32 Intel Architecture Software Developer's Manual, Volume 3A: System Programming Guide, Part 1, June 2006, which is hereby incorporated by reference in its entirety for all intents and purposes. In particular, page tables include page table entries (PTE), each of which stores a physical page address of a physical memory page and attributes of the physical memory page. The process of taking a virtual memory page address and using it to traverse the page table hierarchy to finally obtain the PTE associated with the virtual address in order to translate the virtual address to a physical address is commonly referred to as a tablewalk.

The latency of a physical system memory access is relatively slow, so that the tablewalk is a relatively costly operation since it involves potentially multiple accesses to physical memory. To avoid incurring the time associated with a tablewalk, processors commonly include a translation lookaside buffer (TLB) caching scheme that caches the virtual to physical address translations. The size and configuration of the TLB impacts performance. A typical TLB configuration may include an L1 TLB and a corresponding L2 TLB. Each TLB is generally configured as an array organized as multiple sets (or rows), in which each set has multiple ways (or columns). As with most caching schemes, the L1 TLB is typically smaller than the L2 TLB with fewer sets and ways, so that it is also faster. Although smaller and faster, it is desired to further reduce the size of the L1 TLB without significantly impacting performance.

The present invention is described herein with reference to TLB caching schemes and the like, where it is understood that the principles and techniques equally apply to any type of microprocessor caching scheme.

### SUMMARY OF THE INVENTION

A cache memory system according to one embodiment includes a primary cache memory and an overflow cache memory, in which the overflow cache memory operates as an eviction array for the primary cache memory, and in which the primary cache memory and the overflow cache memory are searched together for a stored value that corresponds with a received search address. The primary cache memory includes a first set of storage locations organized as multiple sets and ways, and the overflow cache memory includes a second set of storage locations organized as a first-in, first-out (FIFO) buffer.

In one embodiment, the primary cache memory and the overflow cache memory collectively form a translation lookaside buffer for storing physical addresses of a main system memory for a microprocessor. The microprocessor may include an address generator that provides a virtual address, which may be used as the search address.

A method of caching data according to one embodiment includes storing a first set of entries in a primary cache memory that is organized as sets and ways, storing a second set of entries in an overflow cache memory that is organized as a FIFO, operating the overflow cache memory as an eviction array for the primary cache memory, and searching the primary cache memory at the same time as searching the overflow cache memory for a stored value that corresponds with a received search address.

### BRIEF DESCRIPTION OF THE DRAWINGS

The benefits, features, and advantages of the present invention will become better understood with regard to the following description, and accompanying drawings where:

FIG. 1 is a simplified block diagram of a microprocessor including a cache memory system implemented according to an embodiment of the present invention;

FIG. 2 is a slightly more detailed block diagram illustrating the interfaces between the front end pipe, the reservations stations, a portion of the MOB, and the ROB of the microprocessor of FIG. 1;

FIG. 3 is a simplified block diagram of portions of the MOB for providing a virtual address (VA) and retrieving a corresponding physical address (PA) of a requested data location in the system memory of the microprocessor of FIG. 1;

FIG. 4 is a block diagram illustrating the L1 TLB of FIG. 3 implemented according to one embodiment of the present invention;

FIG. 5 is a block diagram illustrating the L1 TLB of FIG. 3 according to a more specific embodiment including a 16 set by 4 way (16×4) primary L1.0 array, and 8 way overflow FIFO buffer L1.5 array; and

FIG. 6 is a block diagram of an eviction process according to one embodiment using the L1 TLB configuration of FIG. 5.

### DETAILED DESCRIPTION

It is desired to reduce the size of the L1 TLB cache array without substantially impacting performance. The inventors have recognized the inefficiencies associated with conventional L1 TLB configurations. For example, the code of most application programs are unable to maximize utilization of the L1 TLB, such that very often a few sets are over-utilized whereas other sets are under-utilized.

The inventors have therefore developed a cache system with a primary cache and an overflow first-in, first-out (FIFO) cache that improves performance and cache memory utilization. The cache system includes an overflow FIFO cache (or L1.5 cache) that serves as an extension to a primary cache array (or L1.0 cache) during cache search, but that also serves as an eviction array for the L1.0 cache. The L1.0 cache is substantially reduced in size compared to a conventional configuration. The overflow cache array, or L1.5 cache, is configured as a FIFO buffer, in which the total number of storage locations of both L1.0 and L1.5 is significantly smaller than a conventional L1 TLB cache. Entries evicted from the L1.0 cache are pushed onto the L1.5 cache, and the L1.0 primary cache and L1.5 cache are searched together to thus extend the apparent size of the L1 cache. Entries pushed off the FIFO buffer are victims of the L1.5 cache and are stored in the L2 cache.

As described herein, a TLB configuration is configured according to the improved cache system to include an overflow TLB (or L1.5 TLB) that serves as an extension to a primary L1 TLB (or L1.0 TLB) during cache search, but that also serves as an eviction array for the L1.0 TLB. The combined TLB configuration extends the apparent size of the smaller L1.0 while achieving similar performance as compared to a larger L1 cache. The primary L1.0 TLB uses an index, such as a conventional virtual address index, whereas the overflow L1.5 TLB array is configured as a FIFO buffer. Although the present invention is described herein with reference to TLB caching schemes and the like, it is understood that the principles and techniques equally apply to any type of hierarchical microprocessor caching scheme.

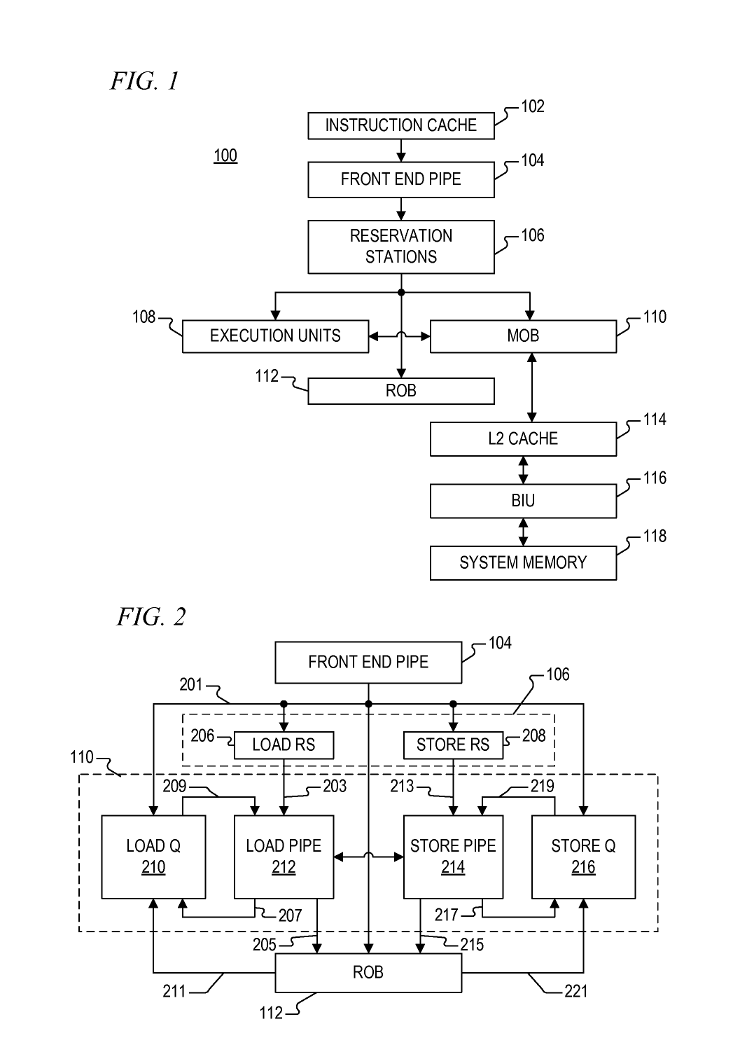

FIG. 1 is a simplified block diagram of a microprocessor 100 including a cache memory system implemented according to an embodiment of the present invention. The macroarchitecture of the microprocessor 100 may be an x86 macroarchitecture in which it can correctly execute a majority of the application programs that are designed to be executed on an x86 microprocessor. An application program is correctly executed if its expected results are obtained. In particular, the microprocessor 100 executes instructions of the x86 instruction set and includes the x86 user-visible register set. The present invention is not limited to x86 architectures, however, in which microprocessor 100 may be according to any alternative architecture as known by those of ordinary skill in the art.

In the illustrated embodiment, the microprocessor 100 includes an instruction cache 102, a front end pipe 104, reservations stations 106, executions units 108, a memory order buffer (MOB) 110, a reorder buffer (ROB) 112, a level-2 (L2) cache 114, and a bus interface unit (BIU) 116 for interfacing and accessing system memory 118. The instruction cache 102 caches program instructions from the system memory 118. The front end pipe 104 fetches program instructions from the instruction cache 102 and decodes them into microinstructions for execution by the microprocessor 100. The front end pipe 104 may include a decoder (not shown) and a translator (not shown) that collectively decode and translate macroinstructions into one or more microinstructions. In one embodiment, instruction translation translates macroinstructions of a macroinstruction set of the microprocessor 100 (such as the x86 instruction set architecture) into microinstructions of a microinstruction set architecture of the microprocessor 100. For example, a memory access instruction may be decoded into a sequence of microinstructions that includes one or more load or store microinstructions. The present disclosure primarily concerns load and store operations and corresponding microinstructions, which are simply referred to herein as load and store instructions. In other embodiments, the load and store instructions may be part of the native instruction set of the microprocessor 100. The front end pipe 104 may also include a register alias table (RAT) (not shown) that generates dependency information for each instruction based on its program order, on the operand sources it specifies, and on renaming information.

The front end pipe 106 dispatches the decoded instructions and their associated dependency information to the reservation stations 106. The reservation stations 106 include queues that hold the instructions and dependency information received from the RAT. The reservation stations 106 also included issue logic that issues the instructions from the queues to the execution units 108 and the MOB 110 when they are ready to be executed. An instruction is ready to be issued and executed when all of its dependencies are resolved. In conjunction with dispatching an instruction, the RAT allocates an entry in the ROB 112 for the instruction. Thus, the instructions are allocated in program order into the ROB 112, which may be configured as a circular queue to guarantee that the instructions are retired in program order. The RAT also provides the dependency information to the ROB 112 for storage in the instruction's entry therein. When the ROB 112 replays an instruction, it provides the dependency information stored in the ROB entry to the reservation stations 106 during the replay of the instruction.

The microprocessor 100 is superscalar and includes multiple execution units and is capable of issuing multiple instructions to the execution units in a single clock cycle. The microprocessor 100 is also configured to perform out-of-order execution. That is, the reservation stations 106 may issue instructions out of the order specified by the program that includes the instructions. Superscalar out-of-order execution microprocessors typically attempt to maintain a relatively large pool of outstanding instructions so that they can take advantage of a larger amount of instruction parallelism. The microprocessor 100 may also perform speculative execution of instructions in which it executes instructions, or at least performs some of the actions prescribed by the instruction, before it is know for certain whether the instruction will actually complete. An instruction may not complete for a variety of reasons, such as a mis-predicted branch instruction, exceptions (interrupts, page faults, divide by zero conditions, general protection errors, etc.), and so forth. Although the microprocessor 100 may perform some of the actions prescribed by the instruction speculatively, the microprocessor does not update the architectural state of the system with the results of an instruction until it is known for certain that the instruction will complete.

The MOB 110 handles interfaces with the system memory 118 via the L2 cache 114 and the BIU 116. The BIU 116 interfaces the microprocessor 100 to a processor bus (not shown) to which the system memory 118 and other devices, such as a system chipset, are coupled. The operating system running on the microprocessor 100 stores page mapping information in the system memory 118, which the microprocessor 100 reads and writes to perform tablewalks, as further described herein. The execution units 108 execute the instructions when issued by the reservation stations 106. In one embodiment, the execution units 108 may include all of the execution units of the microprocessor, such as arithmetic logic units (ALUs) and the like. In the illustrated embodiment, the MOB 110 incorporates the load and store execution units for executing load and store instructions for accessing the system memory 118 as further described herein. The execution units 108 interface the MOB 110 when accessing the system memory 118.

FIG. 2 is a slightly more detailed block diagram illustrating the interfaces between the front end pipe 104, the reservations stations 106, a portion of the MOB 110, and the ROB 112. In this configuration, the MOB 110 generally operates to receive and execute both load and store instructions. The reservations stations 106 is shown divided into a load reservation station (RS) 206 and a store RS 208. The MOB 110 includes a load queue (load Q) 210 and a load pipe 212 for load instructions and further includes a store pipe 214 and a store Q 216 for store instructions. In general, the MOB 110 resolves load addresses for load instructions and resolves store addresses for store instructions using the source operands specified by the load and store instructions. The sources of the operands may be architectural registers (not shown), constants, and/or displacements specified by the instruction. The MOB 110 also reads load data from a data cache at the computed load address. The MOB 110 also writes store data to the data cache at the computed store address.

The front end pipe 104 has an output 201 that pushes load and store instruction entries in program order, in which the load instructions are loaded in order into the load Q 210, the load RS 206 and the ROB 112. The load Q 210 stores all active load instructions in the system. The load RS 206 schedules execution of the load instructions, and when “ready” for execution, such as when its operands are available, the load RS 206 pushes the load instruction via output 203 into the load pipe 212 for execution. Load instructions may be performed out of order and speculatively in the illustrated configuration. When the load instruction has completed, the load pipe 212 provides a complete indication 205 to the ROB 112. If for any reason the load instruction is unable to complete, the load pipe 212 instead issues an incomplete indication 207 to the load Q 210, so that the load Q 210 now controls the status of the uncompleted load instruction. When the load Q 210 determines that the uncompleted load instruction can be replayed, it sends a replay indication 209 to the load pipe 212 where the load instruction is re-executed (replayed), though this time the load instruction is loaded from the load Q 210. The ROB 112 ensures in-order retirement of instructions in the order of the original program. When a completed load instruction is ready to be retired, meaning that it is the oldest instruction in the ROB 112 in program order, the ROB 112 issues a retirement indication 211 to the load Q 210 and the load instruction is effectively popped from the load Q 210.

The store instruction entries are pushed in program order into the store Q 216, the store RS 208 and the ROB 112. The store Q 216 stores all active stores in the system. The store RS 208 schedules execution of the store instructions, and when “ready” for execution, such as when its operands are available, the store RS 208 pushes the store instruction via output 213 into the store pipe 214 for execution. Although store instructions may be executed out of program order, they are not committed speculatively. A store instruction has an execution phase in which it generates its addresses, does exception checking, gains ownership of the line, etc., which may be done speculatively or out-of-order. The store instruction then has its commit phase where it actually does the data write which is not speculative or out-of-order. Store and load instructions compare against each other when being executed. When the store instruction has completed, the store pipe 214 provides a complete indication 215 to the ROB 112. If for any reason the store instruction is unable to complete, the store pipe 214 instead issues an incomplete indication 217 to the store Q 216 so that the store Q 216 now controls the status of the uncompleted store instruction. When the store Q 216 determines that the uncompleted store instruction can be replayed, it sends a replay indication 219 to the store pipe 214 where the store instruction is re-executed (replayed), though this time the store instruction is loaded from the store Q 216. When a completed store instruction is ready to be retired, the ROB 112 issues a retirement indication 221 to the store Q 216 and the store instruction is effectively popped from the store Q 216.

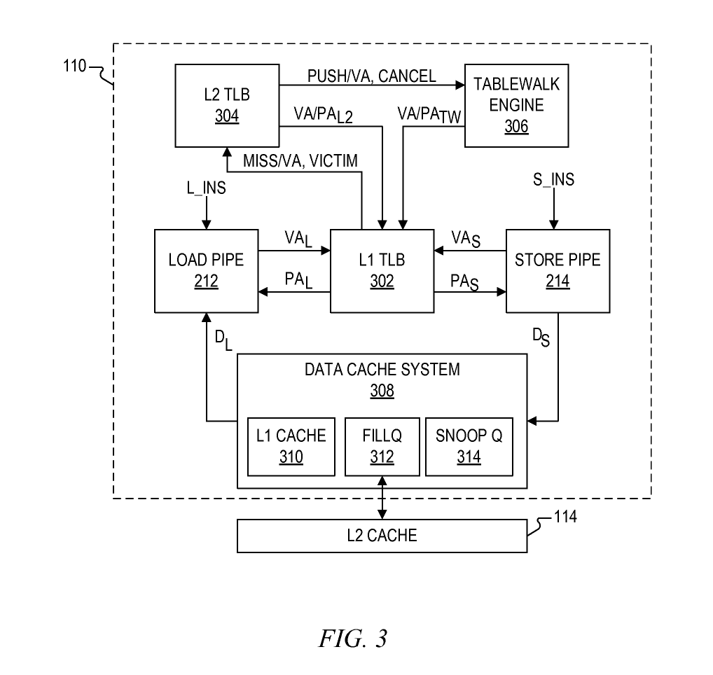

FIG. 3 is a simplified block diagram of portions of the MOB 110 for providing a virtual address (VA) and retrieving a corresponding physical address (PA) of a requested data location in the system memory 118. A virtual address space is referenced using a set of virtual addresses (also known as “linear” addresses or the like) that an operating system makes available to a given process. The load pipe 212 is shown receiving a load instruction L_INS and the store pipe 214 is shown receiving a store instruction S_INS, in which both L_INS and S_INS are memory access instructions for data ultimately located at corresponding physical addresses in the system memory 118. In response to L_INS, the load pipe 212 generates a virtual address, shown as VA_{L}. Similarly, in response to S_INS, the store pipe 214 generates a virtual address, shown as VA_{S}. The virtual addresses VA_{L} and VA_{S} may be generally referred to as search addresses for searching the cache memory system (e.g., TLB cache system) for data or other information that corresponds with the search address (e.g., physical addresses that correspond with the virtual addresses). In the illustrated configuration, the MOB 110 includes a level-1 translation lookaside buffer (L1 TLB) 302 which caches a limited number of physical addresses for corresponding virtual addresses. In the event of a hit, the L1 TLB 302 outputs the corresponding physical address to the requesting device. Thus, if VA_{L} generates a hit, then the L1 TLB 302 outputs a corresponding physical address PA_{L} for the load pipe 212, and if VA_{S} generates a hit, then the L1 TLB 302 outputs a corresponding physical address PAₛ for the store pipe 214.

The load pipe 212 may then apply the retrieved physical address PA_{L} to a data cache system 308 for accessing the requested data. The cache system 308 includes a data L1 cache 310, and if the data corresponding with the physical address PA_{L} is stored therein (a cache hit), then the retrieved data, shown as D_{L}, is provided to the load pipe 212. If the L1 cache 310 suffers a miss such that the requested data D_{L} is not stored in the L1 cache 310, then ultimately the data is retrieved either from the L2 cache 114 or the system memory 118. The data cache system 308 further includes a FILLQ 312 that interfaces the L2 cache 114 for loading cache lines into the L2 cache 114. The data cache system 308 further includes a snoop Q 314 that maintains cache coherency of the L1 and L2 caches 310 and 114. Operation is similar for the store pipe 214, in which the store pipe 214 uses the retrieved physical address PAₛ to store corresponding data D_{S} into the memory system (L1, L2 or system memory) via the data cache system 308. Operation of the data cache system 308 and interfacing the L2 cache 114 and the system memory 118 is not further described. It is nonetheless understood that the principles of the present invention may equally be applied to the data cache system 308 in an analogous manner.

The L1 TLB 302 is a limited resource so that initially, and periodically thereafter, the requested physical address corresponding to the virtual address is not stored therein. If the physical address is not stored, then the L1 TLB 302 asserts a “MISS” indication to the L2 TLB 304 along with the corresponding virtual address VA (either VA_{L} or VA_{S}) to determine whether it stores the physical address corresponding with the provided virtual address. Although the physical address may be stored within the L2 TLB 304, it nonetheless pushes a tablewalk to a tablewalk engine 306 along with the provided virtual address (PUSH/VA). The tablewalk engine 306 responsively initiates a tablewalk in order to obtain the physical address translation of the virtual address VA missing in the L1 and L2 TLBs. The L2 TLB 304 is larger and stores more entries but is slower than the L1 TLB 302. If the physical address, shown as PA_{L2}, corresponding with the virtual address VA is found within the L2 TLB 304, then the corresponding tablewalk operation pushed into the tablewalk engine 306 is canceled, and the virtual address VA and the corresponding physical address PA_{L2} is provided to the L1 TLB 302 for storage therein. An indication is provided back to the requesting entity, such as the load pipe 212 (and/or the load Q 210) or the store pipe 214 (and/or the store Q 216), so that a subsequent request using the corresponding virtual address allow the L1 TLB 302 to provide the corresponding physical address (e.g., a hit).

If instead the request also misses in the L2 TLB 304, then the tablewalk process performed by the tablewalk engine 306 eventually completes and provides the retrieved physical address, shown as PA_{TW} (corresponding with the virtual address VA), back to the L1 TLB 302 for storage therein. When a miss occurs in the L1 TLB 304 such that the physical address is provided by either the L2 TLB 304 or the tablewalk engine 306, and if the retrieved physical address evicts an otherwise valid entry within the L1 TLB 302, then the evicted entry or “victim” is stored in the L2 TLB. Any victim of the L2 TLB 304 is simply pushed out in favor of the newly acquired physical address.

The latency of each access to the physical system memory 118 is slow, so that the tablewalk process, which may involve multiple system memory 118 accesses, is a relatively costly operation. The L1 TLB 302 is configured in such a manner to improve performance as compared to conventional L1 TLB configurations as further described herein. In one embodiment, the size of the L1 TLB 302 is smaller with less physical storage locations than a corresponding conventional L1 TLB, but achieves similar performance for many program routines as further described herein.

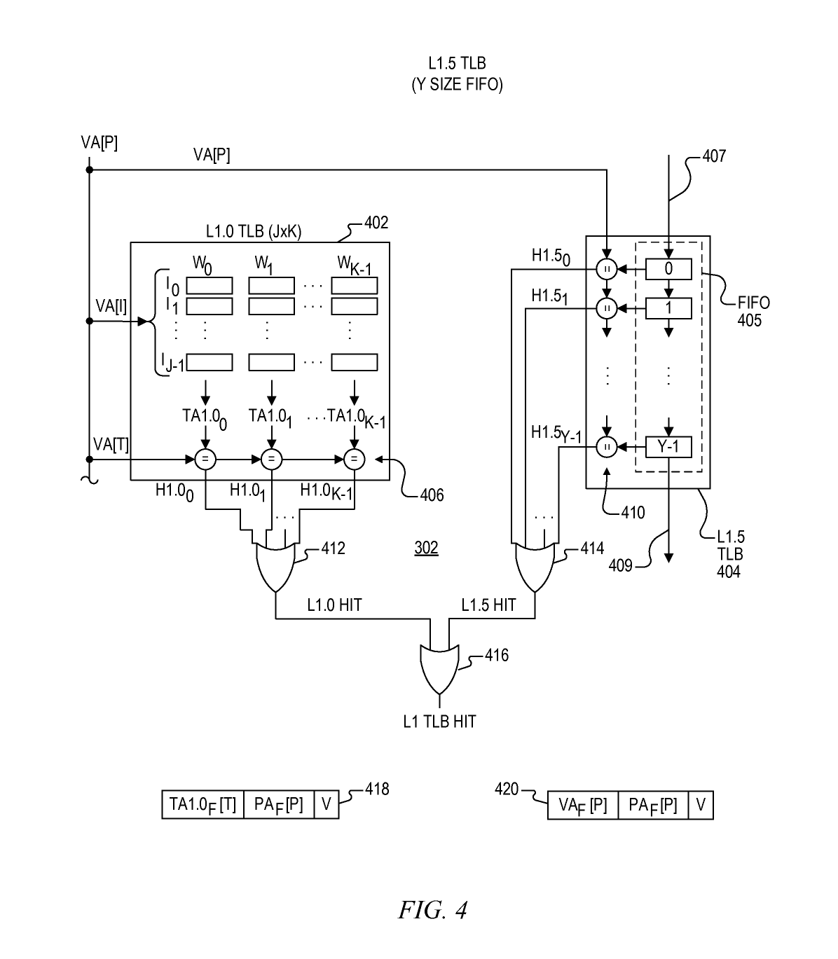

FIG. 4 is a block diagram illustrating the L1 TLB 302 implemented according to one embodiment of the present invention. The L1 TLB 302 includes a first or primary TLB, denoted L1.0 TLB 402, and an overflow TLB, denoted L1.5 TLB 404, in which the notations “1.0” and “1.5” are used to distinguish between each other and between the overall L1 TLB 302. In one embodiment, the L1.0 TLB 402 is a set-associative cache array including multiple sets and ways, in which the L1.0 TLB 402 is a J×K array of storage locations including J sets (indexed I₀ to I_{J-1}) and K ways (indexed W₀ to W_{K-1}), in which J and K are each integers greater than one. Each of the J×K storage locations has a size suitable for storing an entry as further described herein. A virtual address to a “page” of information stored in the system memory 118, denoted VA[P], is used for accessing (searching) each storage location of the L1.0 TLB 402. The “P” denotes a page of information including only the upper bits of the full virtual address sufficient to address each page. For example, if a page of information has a size of 2¹²=4,096 (4K), then lower 12 bits [11 . . . 0] are discarded so that VA[P] only includes the remaining upper bits.

When VA[P] is provided for searching the L1.0 TLB 402, a lower sequential number of bits “I” of the VA[P] address (just above the discarded lower bits of the full virtual address) are used as an index VA[I] to address a selected set of the L1.0 TLB 402. The number of index bits “I” for the L1.0 TLB 402 is determined as LOG₂(J)=I. For example, if the L1.0 TLB 402 has 16 sets, then the index address VA[I] is the lowest 4 bits of the page address VA[P]. The remaining upper bits “T” of the VA[P] address are used as a tag value VA[T] for comparing to the tag values of each of the ways of the selected set using a set of comparators 406 of the L1.0 TLB 402. In this manner, the index VA[I] selects one set or row of the storage locations of the L1 TLB 402, and a tag value stored within each of the K ways of the selected set, shown as TA1.0₀, TA1.0₁, . . . , TA1.0_{K-1}, are each compared with the tag value VA[T] by the comparators 406 for determining a corresponding set of hit bits H1.0₀, H1.0₁, . . . , H1.0_{K-1}.

The L1.5 TLB 404 includes a first-in, first-out (FIFO) buffer 405 including a number Y of storage locations 0, 1, . . . , Y−1, in which Y is an integer greater than one. Unlike conventional cache arrays, the L1.5 TLB 404 is not indexed. Instead, new entries are simply pushed into one end of the FIFO buffer 405, shown as a tail 407 of the FIFO buffer 405, and evicted entries are pushed out of the other end of the FIFO buffer 405, shown as a head 409 of the FIFO buffer 405. Since the L1.5 TLB 404 is not indexed, each storage location of the FIFO buffer 405 has a size suitable for storing an entry including a full virtual page address along with a corresponding physical page address. The L1.5 TLB 404 includes a set of comparators 410, each having one input coupled to a corresponding storage location of the FIFO buffer 405 for receiving a corresponding one of the stored entries. When searching the L1.5 TLB 404, VA[P] is provided to the other input of each of the set of comparators 410, which compare VA[P] with a corresponding address of each stored entry for determining a corresponding set of hit bits H1.5₀, H1.5₁, . . . , H1.5_{Y-1}.

The L1.0 TLB 402 and the L1.5 TLB 404 are searched together. The hit bits H1.0₀, H1.0₁, . . . , H1.0_{X-1} from the L1.0 TLB 402 are provided to corresponding inputs of a K-input logic OR gate 412 for providing a hit signal L1.0 HIT indicating a hit within the L1.0 TLB 402 when any one of the selected tag values TA1.0₀, TA1.0₁, . . . , TA1.0_{K-1} is equal to the tag value VA[T]. Also, the hit bits H1.5₀, H1.5₁, . . . , H1.5_{Y-1} of the L1.5 TLB 404 are provided to corresponding inputs of a Y-input logic OR gate 414 for providing a hit signal L1.5 HIT indicating a hit within the L1.5 TLB 404 when any a page address of one of the entries of the L1.5 TLB 404 is equal to the page address VA[P]. The L1.0 HIT signal and the L1.5 HIT signal are provided to the inputs of a 2-input logic OR gate 416 providing a hit signal L1 TLB HIT. Thus, L1 TLB HIT indicates a hit within the overall L1 TLB 302.

Each storage location of the L1.0 cache 402 is configured to store an entry having a form illustrated by entry 418. Each storage location includes a tag field TA1.0_{F}[T] (subscript “F” denoting a field) for storing an entry's tag value having the same number of tag bits “T” as the tag value VA[T] for comparison by a corresponding one of the comparators 406. Each storage location includes a physical page field PA_{F}[P] for storing the entry's physical page address for accessing a corresponding page in the system memory 118. Each storage location includes a valid field “V” including one or more bits indicating whether the entry is currently valid. A replacement vector (not shown) may be provided for each set used for determining a replacement policy. For example, if all of the ways of a given set are valid and a new entry is to replace one of the entries in the set, then the replacement vector is used to determine which of the valid entries to evict. The evicted entry is then pushed onto the FIFO buffer 405 of the L1.5 cache 404. In one embodiment, for example, the replacement vector is implemented according to a least recently used (LRU) policy such that the least recently used entry is targeted for eviction and replacement. The illustrated entry format may include additional information (not shown), such as status information or the like for the corresponding page.

Each storage location of the FIFO buffer 405 of the L1.5 cache 404 is configured to store an entry having a form illustrated by entry 420. Each storage location includes a virtual address field VA_{F}[P] for storing an entry's virtual page address VA[P] having “P” bits. In this case, rather than storing a portion of each virtual page address as a tag, an entire virtual page address is stored in the virtual address field VA_{F}[P] of the entry. Each storage location further includes a physical page field PA_{F}[P] for storing the entry's physical page address for accessing a corresponding page in the system memory 118. Also, each storage location includes a valid field “V” including one or more bits indicating whether the entry is currently valid. The illustrated entry format may include additional information (not shown), such as status information or the like for the corresponding page.

The L1.0 TLB 402 and the L1.5 TLB 404 are accessed at the same time, or during the same clock cycle, so that the collective entries of both TLBs are searched together. Also, the L1.5 TLB 404 serves as an overflow TLB for the L1.0 TLB 402 in that victims evicted from the L1.0 TLB 402 are pushed onto the FIFO buffer 405 of the L1.5 TLB 404. When a hit occurs within the L1 TLB 302 (L1 TLB HIT), then the corresponding physical address entry PA[P] is retrieved from the corresponding storage location within either the L1.0 TLB 402 or the L1.5 TLB 404 that indicated a hit. The L1.5 TLB 404 increases the total number of entries that may be stored by the L1 TLB 302 to increase utilization. In a conventional TLB configuration, certain sets are overused while others are underused based on a singular indexing scheme. The use of an overflow FIFO buffer improves overall utilization so that the L1 TLB 302 appears as a larger array even though it has significantly less storage locations and is physically reduced in size. Since some rows of the conventional TLB are overused, the L1.5 TLB 404 serves as an overflow FIFO buffer causing the L1 TLB 302 to appear as though it has a greater number of storage locations than it actually has. In this manner, the overall L1 TLB 302 generally has a greater performance than one larger TLB of having the same number of entries.

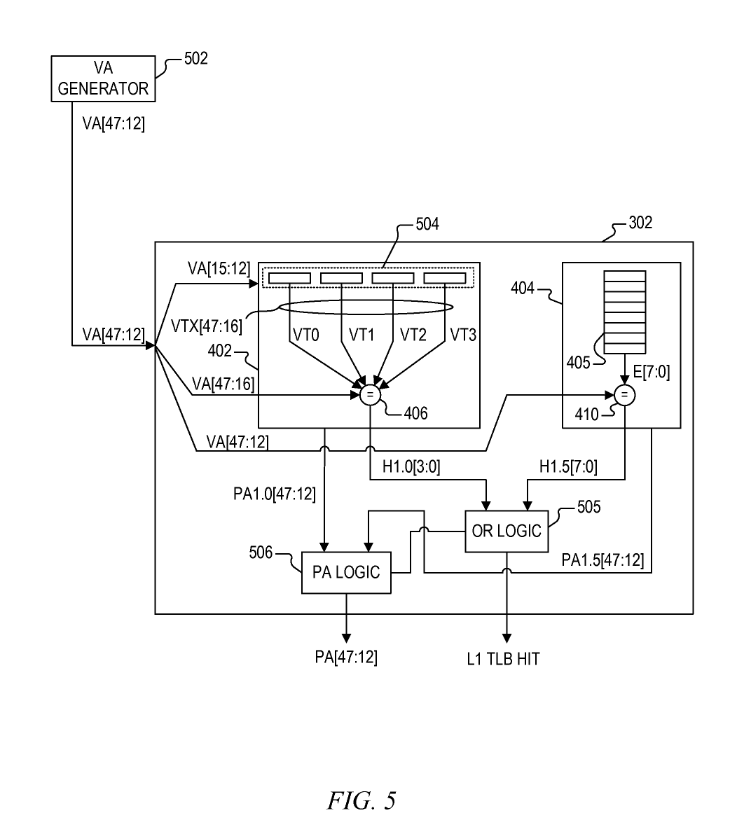

FIG. 5 is a block diagram illustrating the L1 TLB 302 according to a more specific embodiment, in which J=16, K=4, and Y=8 so that the L1.0 TLB 402 is a 16 set by 4 way array (16×4) of storage locations, and the L1.5 TLB 404 includes the FIFO buffer 405 with 8 storage locations. Also, the virtual address is 48 bits, denoted VA[47:0], and the page size is 4K. A virtual address generator 502 within both the load and store pipes 212, 214 provides the upper 36 bits of the virtual address, or VA[47:12], in which the lower 12 bits are discarded since addressing a 4K page of data. In one embodiment, the VA generator 502 performs an add calculation to provide the virtual address which is used as a search address for the L1 TLB 302. VA[47:12] is provided to corresponding inputs of the L1 TLB 302.

The lower 4 bits of the virtual address form the index VA[15:12] provided to the L1.0 TLB 402 for addressing one of the 16 sets, shown as a selected set 504. The remaining higher bits of the virtual address form the tag value VA[47:16] which is provided to inputs of the comparators 406. The tag values VT0-VT3 of each stored entry of the 4 ways of the selected set 504, each having the form VTX[47:16], are provided to respective inputs of the comparators 406 for comparing with the tag value VA[47:16]. The comparators 406 output four hit bits H1.0[3:0]. If there is a hit in any of the four selected entries, then the corresponding physical address PA1.0[47:12] is also provided as an output of the L1.0 TLB 402.

The virtual address VA[47:12] is also provided to one input of each of the set of comparators 410 of the L1.5 TLB 404. Each of the eight entries of the L1.5 TLB 404 are provided to the other input of a corresponding one of the set of comparators 410, which output eight hit bits H1.5[7:0]. If there is a hit in any one of the entries of the FIFO buffer 405, then the corresponding physical address PA1.5[47:12] is also provided as an output of the L1.5 TLB 404.

The hit bits H1.0[3:0] and H1.5[7:0] are provided to respective inputs of OR logic 505, representing the OR gates 412, 414 and 416, which outputs the hit bit L1 TLB HIT for the L1 TLB 302. The physical addresses PA1.0[47:12] and PA1.5[47:12] is provided to respective inputs of PA logic 506, which outputs the physical address PA[47:12] of the L1 TLB 302. In the event of a hit, only one of the physical addresses PA1.0[47:12] and PA1.5[47:12] may be valid, and in the event of a miss, neither physical address output is valid. Although not shown, the validity information from the valid fields of the storage location indicative of a hit may also be provided. The PA logic 506 may be configured as select or multiplexer (MUX) logic or the like for selecting a valid one of the physical addresses of the L1.0 and L1.5 TLBs 402, 404. HU TLB HIT is not asserted indicating a MISS for the L1 TLB 302, then the corresponding physical address PA[47:12] is ignored or otherwise discarded as invalid.

The L1 TLB 302 shown in FIG. 5 includes 16×4 (L1.0)+8 (L1.5) storage locations for storing a total of 72 entries. A prior conventional configuration for the L1 TLB was configured as a 16×12 array for storing a total of 192 entries, which has more than two and a half the number of storage locations of the L1 TLB 302. The FIFO buffer 405 of the L1.5 TLB 404 serves as an overflow for any of the sets and ways of the L1.0 TLB 402, so that utilization of the sets and ways of the L1 TLB 302 is improved relative to the conventional configuration. More specifically, the FIFO buffer 405 stores any entry that was evicted from the L1.0 TLB 402 regardless of set or way utilization.

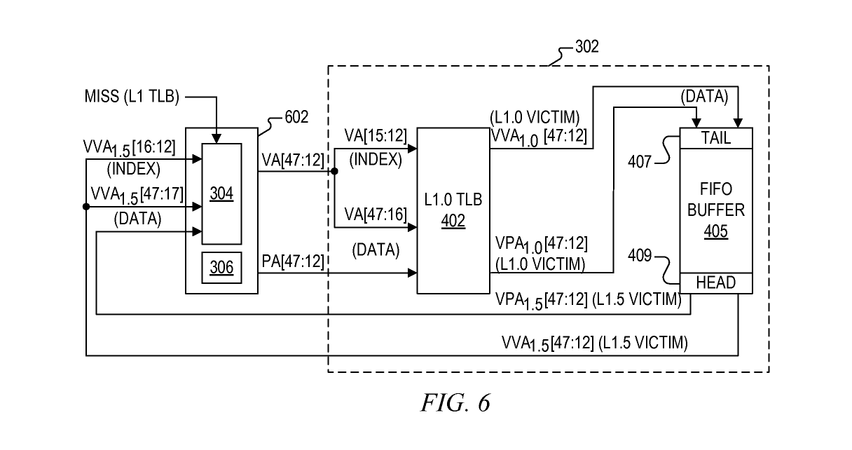

FIG. 6 is a block diagram of an eviction process according to one embodiment using the L1 TLB 302 configuration of FIG. 5. The process is equally applicable to the more general configuration of FIG. 4. The L2 TLB 304 and the tablewalk engine 306 are shown collectively within a block 602. When a miss occurs in the L1 TLB 302 as shown in FIG. 3, a MISS indication is provided to the L2 TLB 304. The lower bits of the virtual address invoking the miss are applied as an index to the L2 TLB 304 to determine whether the corresponding physical address is stored therein. Also, a tablewalk is pushed to the tablewalk engine 306 using the same virtual address. Either the L2 TLB 304 or the tablewalk engine 306 returns with the virtual address VA[47:12] along with the corresponding physical address PA[47:12], both shown as outputs of the block 602. The lower 4 bits of the virtual address VA[15:12] are applied as the index to the L1.0 TLB 402, and the remaining upper bits of the virtual address VA[47:16] and the corresponding returned physical address PA[47:12] are stored as an entry within the L1.0 TLB 402. As shown in FIG. 4, the VA[47:16] bits form the new tag value TA1.0 and the physical address PA[47:12] forms the new PA[P] page value stored within the accessed storage location. The entry is marked as valid according to the applicable replacement policy.

The index VA[15:12] provided to the L1.0 TLB 402 addresses a corresponding set within the L1.0 TLB 402. If there is at least one invalid entry (or way) of the corresponding set, then the new data is stored within the otherwise “empty” storage location without causing a victim. If, however, there are no invalid entries, then one of the valid entries is evicted and replaced with the new data, and the L1.0 TLB 402 outputs the corresponding victim. The determination of which valid entry or way to replace with the new entry is based on a replacement policy, such as according to the least-recently used (LRU) scheme, a pseudo-LRU scheme, or any suitable replacement policy or scheme. The victim of the L1.0 TLB 402 includes a victim virtual address VVA_{1.0}[47:12] and a corresponding victim physical address VPA_{1.0}[42:12]. The evicted entry from the L1.0 TLB 402 includes the previously stored tag value (TA1.0), which is used as the upper bits VVA_{1.0}[47:16] of the victim virtual address. The lower bits VVA_{1.0}[15:12] of the victim virtual address are the same as the index of the set from which the entry was evicted. For example, the index VA[15:12] may be used as VVA_{1.0}[15:12], or else corresponding internal index bits of the set from which the tag value was evicted may be used. The tag value and the index bits are appended together to form the victim virtual address VVA_{1.0}[47:12].

The victim virtual address VVA_{1.0}[47:12] and the corresponding victim physical address VPA_{1.0}[47:12] collectively form an entry that is pushed into a storage location at the tail 407 of the FIFO buffer 405 of the L1.5 TLB 404. If the L1.5 TLB 404 was not full prior to receiving the new entry, or if it otherwise includes at least one invalid entry, then it may not evict a victim entry. If, however, the L1.5 TLB 404 was already full of entries (or at least full of valid entries), then the last entry at the head 409 of the FIFO buffer 405 is pushed out and evicted as a victim of the L1.5 TLB 404. The victim of the L1.5 TLB 404 includes a victim virtual address VVA_{1.5}[47:12] and a corresponding victim physical address VPA_{1.5}[47:12]. In the illustrated configuration, the L2 TLB 304 is larger and includes 32 sets, so that the lower five bits of the victim virtual address VVA_{1.5}[16:12] from the L1.5 TLB 404 are provided as the index to the L2 TLB 304 for accessing a corresponding set. The remaining upper victim virtual address bits VVA_{1.5}[47:17] and the victim physical address VPA_{1.5}[47:12] are provided as an entry to the L2 TLB 304. These data values are stored in an invalid entry of the indexed set within the L2 TLB 304, if any, or otherwise in a selected valid entry evicting a previously stored entry. Any entry evicted from the L2 TLB 304 may simply be discarded in favor of the new data.

Various methods may be used for implementing and/or managing the FIFO buffer 405. Upon power on or reset (POR), the FIFO buffer 405 may be initialized as an empty buffer or otherwise by marking each entry as invalid. Initially, new entries (victims of the L1.0 TLB 402) are placed at the tail 407 of the FIFO buffer 405 without causing victims until the FIFO buffer 405 becomes full. When a new entry is added to the tail 407 when the FIFO buffer 405 is full, then the entry at the head 409 is pushed out or “popped” off the FIFO buffer 405 as the victim VPA_{1.5}, which may then be provided to corresponding inputs of the L2 TLB 304 as previously described.

During operation, a previously valid entry may be marked as invalid. In one embodiment, an invalid entry remains as an entry until pushed out the head of the FIFO buffer 405, in which case it is discarded and not stored in the L2 TLB 304. In another embodiment, when an otherwise valid entry is marked as invalid, existing values may be shifted so that invalid entries are replaced by valid entries. Alternatively, new values are stored in invalidated storage locations and pointer variables are updated to maintain FIFO operation. These later embodiments, however, increase the complexity of FIFO operation and may not be advantageous in certain embodiments.

The foregoing description has been presented to enable one of ordinary skill in the art to make and use the present invention as provided within the context of a particular application and its requirements. Although the present invention has been described in considerable detail with reference to certain preferred versions thereof, other versions and variations are possible and contemplated. Various modifications to the preferred embodiments will be apparent to one skilled in the art, and the general principles defined herein may be applied to other embodiments. For example, the circuits described herein may be implemented in any suitable manner including logic devices or circuitry or the like. Also, although the present invention is illustrated by way of TLB arrays and the like, the concepts may equally be applied to any multiple level cache scheme in which a first cache array is indexed differently than a second cache array. The different indexing scheme provides increased utilization of cache sets and ways and thus improved performance.

Those skilled in the art should appreciate that they can readily use the disclosed conception and specific embodiments as a basis for designing or modifying other structures for carrying out the same purposes of the present invention without departing from the spirit and scope of the invention. Therefore, the present invention is not intended to be limited to the particular embodiments shown and described herein, but is to be accorded the widest scope consistent with the principles and novel features herein disclosed.

What is claimed is:

1. A cache memory system, comprising:
a primary cache memory including a first plurality of storage locations organized as a plurality of sets and a corresponding plurality of ways;
an overflow cache memory that operates as an eviction array for said primary cache memory, wherein said overflow cache memory includes a second plurality of storage locations organized as a first-in, first-out buffer; and
wherein said primary cache memory and said overflow cache memory are searched together for a stored value that corresponds with a received search address.

2. The cache memory system of claim 1, wherein said overflow cache array comprises N storage locations and N corresponding comparators, wherein each of said N storage locations stores a corresponding one of N stored addresses and a corresponding one of N stored values, and wherein each of said N comparators compares said search address with a corresponding one of said N stored addresses to determine a hit within said overflow cache array.

3. The cache memory system of claim 2, wherein said N stored addresses and said search address each comprise a virtual address, wherein each of said N stored values comprises a corresponding one of N physical addresses, and wherein said overflow cache array outputs a corresponding one of said N physical addresses that corresponds with said search address when said hit occurs.

4. The cache memory system of claim 1, wherein an entry stored within any one of said first plurality of storage locations that is evicted from said primary cache memory is pushed onto said first-in, first-out buffer of said overflow cache memory.

5. The cache memory system of claim 1, further comprising:
a level two cache;
wherein said primary cache memory and said overflow cache memory collectively comprise a level one cache; and
wherein an entry stored within one of said second plurality of storage locations that is evicted from said overflow cache memory is stored in said level two cache.

6. The cache memory system of claim 1, wherein said primary cache memory and said overflow cache memory each comprise a translation lookaside buffer for storing a plurality of physical addresses of a main system memory for a microprocessor.

7. The cache memory system of claim 1, wherein said primary cache memory comprises 16 sets by 4 ways of storage locations, and wherein said first-in, first-out buffer of said overflow cache memory comprises 8 storage locations.

8. The cache memory system of claim 1, further comprising:
logic that combines a first number of hit signals and a second number of hit signals into one hit signal;
wherein said primary cache memory comprises said first number of ways and a corresponding first number of comparators providing said first number of hit signals; and
wherein said overflow cache memory comprises said second number of comparators providing said second number of hit signals.

9. The cache memory system of claim 1, wherein:
said primary cache memory is operative to evict a tag value from one of said first plurality of storage locations within said primary cache memory and to form a victim address by appending said evicted tag value with an index value stored within said one of said first plurality of storage locations, and to evict a victim value from said one of said first plurality of storage locations that corresponds with said victim address; and
wherein said victim address and said victim value collectively form a new entry that is pushed onto said first-in, first out buffer of said overflow cache array.

10. The cache memory system of claim 1, further comprising:
wherein a retrieved entry for storage into said primary cache memory includes an address comprising a tag value and a primary index, wherein said primary index is provided to an index input of said primary cache memory, and wherein said tag value is provided to a data input of said primary cache memory;
wherein said primary cache memory is operative to select an entry corresponding to one of said plurality of ways of a set indicated by said primary index, to evict a tag value from said selected entry and to form a victim address by appending said evicted tag value with an index value of said selected entry, and to evict a victim value from said selected entry that corresponds with said victim address; and
wherein said victim address and said victim value collectively form a new entry pushed onto said first-in, first out buffer of said overflow cache array.

11. A microprocessor, comprising:
an address generator that provides a virtual address; and
a cache memory system, comprising:
a primary cache memory including a first plurality of storage locations organized as a plurality of sets and a corresponding plurality of ways;
an overflow cache memory that operates as an eviction array for said primary cache memory, wherein said overflow cache memory includes a second plurality of storage locations organized as a first-in, first-out buffer; and
wherein said primary cache memory and said overflow cache memory are searched together for a stored physical address that corresponds with said virtual address.

12. The microprocessor of claim 11, wherein said overflow cache array comprises N storage locations and N corresponding comparators, wherein each of said N storage locations stores a corresponding one of N stored virtual addresses and a corresponding one of N physical addresses, and wherein each of said N comparators compares said virtual address from said address generator with a corresponding one of said N stored virtual addresses to determine a hit within said overflow cache array.

13. The microprocessor of claim 11, wherein an entry stored within any one of said first plurality of storage locations that is evicted from said primary cache memory is pushed onto said first-in, first-out buffer of said overflow cache memory.

14. The microprocessor of claim 11, wherein:
said cache memory system includes a level two cache;
wherein said primary cache memory and said overflow cache memory collectively comprise a level one cache; and
wherein an entry evicted from said overflow cache memory is stored in said level two cache.

15. The microprocessor of claim 14, further comprising:
a tablewalk engine that accesses system memory to retrieve said stored physical address when a miss occurs in said cache memory system;
wherein said stored physical address found in either one of said level two cache and said system memory is stored in said primary cache memory; and
wherein an entry evicted from said primary cache memory is pushed onto said first-in, first-out buffer of said overflow cache memory.

16. The microprocessor of claim 11, wherein said cache memory system further comprises:
logic that combines a first plurality of hit signals and a second plurality of hit signals into one hit signal for said cache memory system;
wherein said primary cache memory comprises said first number of ways and a corresponding first number of comparators providing said first number of hit signals; and
wherein said overflow cache memory comprises said second number of comparators providing said second number of hit signals.

17. The microprocessor of claim 11, wherein said cache memory system comprises a level one translation lookaside buffer for storing a plurality of physical addresses that correspond with a plurality of virtual addresses.

18. The microprocessor of claim 17, further comprising:
a tablewalk engine that accesses system memory when a miss occurs in said cache memory system; and
wherein said cache memory system includes a level two translation lookaside buffer that forms an eviction array for said overflow cache memory, and wherein said level two translation lookaside buffer is searched when a miss occurs in said primary cache memory and said overflow cache memory.

19. A method of caching data, comprising:
storing a first plurality of entries in a primary cache memory that is organized as a plurality of sets and a corresponding plurality of ways;
storing a second plurality of entries in an overflow cache memory that is organized as a first-in, first-out buffer;
operating the overflow cache memory as an eviction array for the primary cache memory; and
searching the primary cache memory at the same time as searching the overflow cache memory for a stored value that corresponds with a received search address.

20. The method of claim 19, wherein said storing a second plurality of entries in an overflow cache memory comprises storing a plurality of virtual addresses and a corresponding plurality of physical addresses.

21. The method of claim 19, wherein said searching the overflow cache memory comprises comparing the received search address with each of a plurality of stored addresses stored in the second plurality of entries of the first-in, first-out buffer to determine if the stored value is stored within the overflow cache memory.

22. The method of claim 19, further comprising:
generating a first hit indication based on said searching the primary cache memory;
generating a second hit indication based on said searching the overflow cache memory;
combining the first and second hit indications to provide a single hit indication.

23. The method of claim 19, further comprising:
evicting a victim entry from the primary cache memory; and
pushing the victim entry of the primary cache memory into the first-in, first-out buffer of the overflow cache memory.

24. The method of claim 23, further comprising pushing out an oldest entry of the first-in, first-out buffer.
